(19) United States
(12) Patent Application Publication
(10) Pub. No.: US 2006/0164778 A1
(43) Pub. Date: Jul. 27, 2006

(54) Inrush current limiting circuit

(76) Inventors: Andrei Beletsky, Woodbury, MN (US); Douglas D. Jensen, Woodbury, MN (US); Richard R. Lemberger, Forest Lake, MN (US)

Correspondence Address: Pamela R. Crocker;Patent Legal Staff, Eastman Kodak Company, 343 State Street, Rochester, NY, 14650-2201, US

(21) Appl. No.: 11/042,300

(22) Filed: Jan. 24, 2005

(51) Int. Cl. H02H 3/00

(52) U.S. Cl. 361/94

(57) ABSTRACT

A current limiting circuit comprises a current limiting element (R1) coupled between an input and an output of the current limiting circuit, and a controllable shunt element (M1) connected in parallel with the current limiting element. The current limiting circuit further comprises a control circuit (102) and a time delay circuit (104). The control circuit is configured to generate a control signal for application to a control input of the shunt element for controlling the shunt element between at least a first state and a second state responsive to a timing signal. The time delay circuit is configured to generate the timing signal, and is coupled between the input of the current limiting circuit and an input of the control circuit. The time delay circuit generates the timing signal based on a designated time constant and in a manner substantially independent of an amount of current passing through the current limiting element.

### FIELD OF THE INVENTION

The present invention relates generally to electrical circuits, and more particularly to electrical circuits operative to limit inrush current resulting from switched connection of a power source to a capacitive load.

### BACKGROUND OF THE INVENTION

It is well known that a substantial inrush current will typically result when a direct current (DC) power source is initially connected to a capacitive load. For example, such a situation arises in systems in which an electromechanical relay or other type of switch is used to provide physical separation of the DC power source and the capacitive load. This physical separation of source and load may be required in order to satisfy safety regulations or to meet other system requirements. However, contacts or other portions of a relay can be damaged by the transient current spikes associated with a large inrush current. For example, the presence of surge current flow or associated voltage potential differences between relay contacts can create excessive erosion of contacts and eventually lead to a condition in which the relay contacts cannot create a reliable connection. In more extreme cases, a sufficiently large inrush current may cause arcing between the relay contacts. This can result in the contacts becoming welded together, thus preventing separation of the power source from the load and creating safety issues.

Inrush current is particularly problematic in systems in which the relay separates the power source from several different capacitive loads connected in parallel. For example, in such a system the capacitive loads may comprise an array of motor drivers, each having a large bypass capacitor with a low equivalent series resistance (ESR). Typically, the worst case condition for the relay is a fully discharged load capacitance which includes several rows of low ESR bypass capacitors connected in parallel. The total load capacitance in a system of this type may reach several millifarads (mF), creating a surge current of several tens of amperes or more, which in most cases exceeds the switching current rating of the relay.

In general, the switching life of a relay can be greatly extended by providing an inrush current limiting circuit that will suppress transient current spikes of the type described above. Numerous such inrush current limiting circuits are known in the art.

An example of an inrush current limiting circuit which uses a positive temperature coefficient thermistor is described in Japanese Patent No. JP63178759, entitled “Rush Current Preventing Circuit.” In this circuit, the positive temperature coefficient thermistor is connected in series between the relay and the load, and a field effect transistor (FET) is connected in parallel with the thermistor. The thermistor limits the current flow during an initial transient upon closing of the relay, while the FET, initially in an off state, is later turned on to effectively bypass the thermistor after the transient has subsided to an acceptable level. A problem with an arrangement of this type is that the switching state of the FET is controlled by the voltage across the thermistor. Thus, the circuit may become ambient-temperature dependent and the actual switching time of the FET may vary depending on the initial thermistor resistance and other conditions.

Other examples involving use of a series current limiting resistor in conjunction with an FET are disclosed in Japanese Patent No. JP9091046, entitled “Rush Current Preventing Circuit,” Japanese Patent No. JP10243555, entitled “Inrush Current Limiting Circuit,” and U.S. Pat. No. 5,079,455, entitled “Surge Current-Limiting Circuit for a Large-Capacitance Load.” In these arrangements, the switching state of the FET is determined by sensing actual transient current or load voltage. Thus, it may be difficult to determine the switching state of the FET with sufficient accuracy to ensure that the inrush current limiting circuit satisfies the current rating requirements of the relay for a given set of source and load parameters.

It is therefore apparent that what is needed is an improved inrush current limiting circuit, configured to avoid the above-described problems associated with conventional circuits which rely on thermistors or the sensing of actual transient current or load voltage.

### SUMMARY OF THE INVENTION

The present invention in accordance with one aspect thereof provides a current limiting circuit comprising a current limiting element coupled between an input and an output of the current limiting circuit, and a controllable shunt element connected in parallel with the current limiting element. The current limiting circuit further comprises a control circuit and a time delay circuit. The control circuit is configured to generate a control signal for application to a control input of the shunt element for controlling the shunt element between at least a first state and a second state responsive to a timing signal. The time delay circuit is configured to generate the timing signal, and is coupled between the input of the current limiting circuit and an input of the control circuit. The time delay circuit generates the timing signal based on a designated time constant and in a manner substantially independent of an amount of current passing through the current limiting element.

In an illustrative embodiment, the current limiting element comprises a current limiting resistor, and the controllable shunt element comprises a metal-oxide-semiconductor FET (MOSFET) device with its gate corresponding to the control input. The MOSFET device is coupled at its source and drain terminals between the input and output of the current limiting circuit.

The control circuit in the illustrative embodiment comprises a bipolar transistor with its base coupled to an output of the time delay circuit. More specifically, the bipolar transistor comprises an NPN bipolar transistor having its collector coupled to the control input of the controllable shunt element and its emitter coupled to a ground potential of the current limiting circuit. The control circuit further comprises a divider circuit having a first resistor and a second resistor, with the collector of the bipolar transistor being coupled via the first resistor of the divider circuit to the gate of the MOSFET device, and the gate of the MOSFET device being connected via the second resistor of the divider circuit to the input of the current limiting circuit.

The time delay circuit in the illustrative embodiment comprises a resistor coupled between the input of the current limiting circuit and the input of the control circuit, and a capacitor coupled between the input of the control circuit and ground potential of the current limiting circuit. Values of the resistor and capacitor establish the designated time constant for generation of the timing signal in a manner substantially independent of an amount of current passing through the current limiting element. The time delay circuit may further comprise an additional resistor, coupled between the input of the control circuit and ground potential, in parallel with the capacitor.

In the illustrative embodiment, the current limiting resistor is operative to suppress current between the input and output of the current limiting circuit in the presence of an initial transient current spike resulting when a power source is coupled to a load via the current limiting circuit. Generally, when the MOSFET device is in the first state, current between the input and output of the current limiting circuit passes primarily through the current limiting resistor, and when the shunt element is in the second state, current between the input and output of the current limiting circuit passes primarily through the MOSFET device.

In accordance with another aspect of the invention, the current limiting circuit may comprise a multi-stage circuit, having at least two current limiting elements arranged in series with one another, and at least two controllable shunt elements each connected in parallel with a corresponding one of the current limiting elements.

The invention in the above-described illustrative embodiment provides an inrush current limiting circuit which utilizes a designated time constant to control switching of the MOSFET in the presence of a transient current spike. This advantageously avoids the problems associated with conventional arrangements that involve the use of thermistors or the sensing of actual transient current or load voltage. For example, the illustrative embodiment allows the switching state of the MOSFET to be determined with sufficient accuracy to ensure that the inrush current limiting circuit satisfies the current rating requirements of the relay for a given set of source and load parameters.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures.

FIG. 1 is a schematic diagram of a system which includes an inrush current limiting circuit in accordance with an illustrative embodiment of the invention.

FIG. 2 is a timing diagram illustrating voltage and current characteristics of the inrush current limiting circuit of FIG. 1.

FIG. 3 is a schematic diagram of a system which includes an inrush current limiting circuit in accordance with another illustrative embodiment of the invention.

### DETAILED DESCRIPTION OF THE INVENTION

The present invention will be described herein using a number of illustrative embodiments. It should be understood, however, that the invention is not limited to the particular circuitry arrangements shown in these embodiments, but is more generally applicable to any inrush current limiting circuit application in which it is desirable to provide improved control of transient suppression.

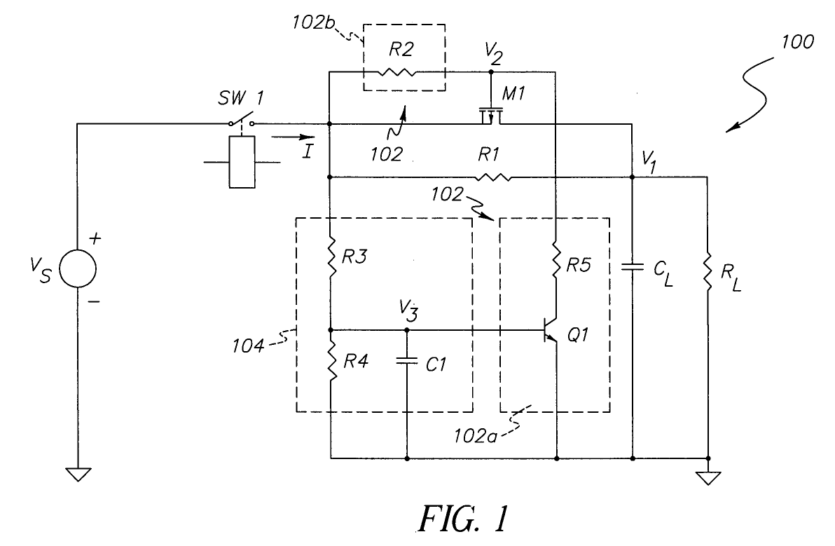

FIG. 1 shows a system 100 which includes an inrush current limiting circuit in accordance with an illustrative embodiment of the invention. The system 100 comprises a DC power source V_{S} which is connectable via a relay SW1 to a load comprising a parallel arrangement of a load capacitance C_{L} and a load resistance R_{L}. In the illustrative embodiments, the power source V_{S} may comprise a 24 volt DC power source, and the relay SW1 may comprise an electromechanical relay having a maximum switching current of approximately 16 amperes (A). It is to be appreciated, however, that this particular power source, relay and load configuration as shown in FIG. 1 is presented by way of illustrative example only. Generally, a current limiting circuit in accordance with the invention may be arranged between any source and load in order to suppress transients which may arise when the source is switched into electrical connection with the load. The particular source V_{S} and load components C_{L} and R_{L} shown herein may be viewed as generic representations of a wide variety of different types and configurations of system elements.

The inrush current limiting circuit is coupled between the relay SW1 and the load, and in this embodiment comprises resistors R1, R2, R3, R4 and R5, capacitor C1, MOSFET M1, and NPN bipolar transistor Q1. More specifically, the current limiting circuit comprises a current limiting resistor R1 coupled between an input and an output of the current limiting circuit, and a p-channel power MOSFET M1 connected at its source and drain terminals in parallel with resistor R1. The current limiting circuit further comprises a control circuit 102, shown in the figure as being separated into portions 102a and 102b collectively comprising bipolar transistor Q1 and resistors R2 and R5, and a time delay circuit 104 comprising resistors R3 and R4 and capacitor C1.

The current limiting resistor R1 may be viewed as an example of what is more generally referred to herein as a current limiting element. In the illustrative embodiment, the current limiting resistor R1 may be, for example, a 2 watt current limiting resistor with a resistance value of about 1 or 2 ohms. It should be understood, however, that these and other component types and values described herein are presented by way of example only, and other component types and values can be used in alternative embodiments as required to accommodate the particular needs of a given application. The current limiting resistor R1 is operative to suppress current between the input and output of the current limiting circuit in the presence of an initial transient current spike resulting when power source V_{S} is switched by relay SW1 into electrical connection with the load.

The power MOSFET M1 may be viewed as an example of what is more generally referred to herein as a controllable shunt element. Although shown as a p-channel power MOSFET, other types of solid state devices or other controllable shunt elements may be used in alternative embodiments of the invention. For example, those skilled in the art will recognize that other types of MOSFETs, such as n-channel MOSFETs, or more generally other solid state devices, may be used as controllable shunt elements herein. Also, alternative embodiments may use other types of solid state devices in place of or in addition to the NPN bipolar device Q1. For example, the circuit can be reconfigured in a straightforward manner to use a PNP bipolar device, or to use one or more field effect devices in place of bipolar transistor Q1.

The power MOSFET M1 is controllable between first and second states, and more particularly between substantially conducting and substantially non-conducting states, also referred to herein as on and off states, respectively. Typically, in the presence of an inrush current transient associated with switching the source V_{S} into electrical connection with the load, M1 is initially in the non-conducting state, such that current between the input and output of the current limiting circuit passes primarily through the current limiting resistor R1 rather than through M1. Later, after an amount of time determined by time delay circuit 104, the initial transient has subsided, and M1 is switched from the non-conducting state to the conducting state, such that current between the input and output of the current limiting circuit passes primarily through M1 rather than R1.

The control circuit 102 is configured to generate a control signal for application to a control input of the shunt element, for controlling the shunt element between its first and second states responsive to a timing signal. In this embodiment, the control input of the shunt element is the gate of the MOSFET M1, and the control circuit 102 includes a voltage divider that is formed by resistors R2 and R5. The gate of M1 is coupled via R5 to the collector of the NPN bipolar transistor Q1, and is coupled via R2 to an input of the current limiting circuit. The base of Q1 is coupled to an output of the time delay circuit 104. The emitter of Q1 is coupled to a particular circuit potential of the current limiting circuit, namely, ground potential.

The time delay circuit 104 is configured to generate a timing signal that is supplied as an input to the control circuit 102. The time delay circuit is coupled between the input of the current limiting circuit and an input of the 102a portion of the control circuit 102. The time delay circuit generates the timing signal based on a designated time constant and in a manner substantially independent of an amount of current passing through the current limiting resistor R1.

More particularly, the time delay circuit 104 in this embodiment comprises resistor R3, which is coupled between the input of the current limiting circuit and the input of the 102a portion of the control circuit 102, and capacitor C1, which is coupled between the 102a portion of the control circuit 102 and a circuit potential of the current limiting circuit. Again, the circuit potential in this example is ground potential, although negative voltage rails or other circuit potentials could be used in alternative embodiments. The values of the resistor and capacitor establish the designated time constant for generation of the timing signal in a manner substantially independent of an amount of current passing through the current limiting resistor R1. The time delay circuit 104 in this embodiment further comprises resistor R4, which is coupled between the input of the portion 102a of control circuit 102 and ground potential, in parallel with the capacitor C1.

In the illustrative embodiments, resistors R2, R3, R4 and R5 may have values of about 47 kohm, 47 kohm, 4.7 kohm and 22 kohm, respectively. Capacitor C1 may have a value of about 10 microfarads (μF). Of course, as indicated previously herein, other component values may be used in implementing a particular embodiment of the invention.

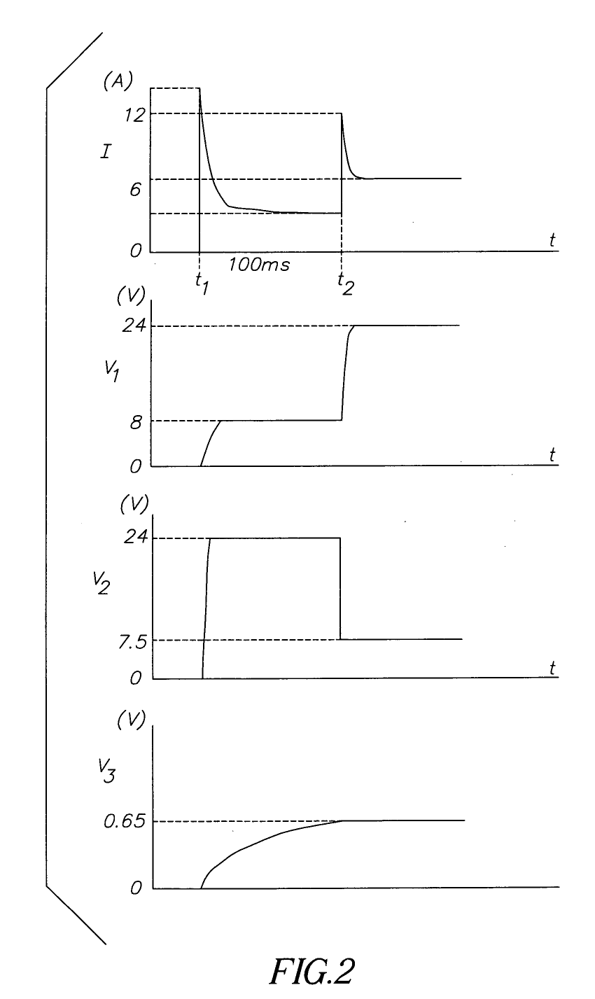

The operation of the current limiting circuit of FIG. 1 will now be described in greater detail, with reference to the timing diagram of FIG. 2. Four plots are shown in FIG. 2, including a plot of inrush current I in amperes (A), as a function of time, at the input to the current limiting circuit, and plots of voltages V₁, V₂ and V₃ in volts (V), all as a function of time. As indicated in FIG. 1, voltage V₁ is the voltage across the load, and voltages V₂ and V₃ are the voltages at the gate of M1 and the base of Q1, respectively. It is assumed that the system is initially configured such that the relay SW1 is in an open position, with power source V_{S} thereby being electrically disconnected from the load. The power source V_{S}, as indicated above, will be assumed for this example to be a 24 volt DC power source.

At time t=t₁, the relay SW1 is closed, and the potential of the power source is immediately applied to the gate of M1 via resistor R2, which places M1 in its off state. At the same time, current from the power source supplied via relay SW1 and resistor R3 starts charging capacitor C1. Initially, the equivalent series resistance of C1 is low and it shunts the resistor R4, thus keeping the base voltage V₃ of Q1 low and Q1 in an off state. During this off state of Q1, the gate voltage V₂ of M1 is unaffected since the high resistance of the emitter-collector path of Q1 ensures that significant current does not flow through resistor R5.

As capacitor C1 continues to charge, the base voltage V₃ of Q1 eventually reaches the switching point of Q1, at time t=t₂, and Q1 transitions from its off state to its on state. When capacitor C1 is fully charged, the base voltage of Q1 is set in accordance with the voltage divider formed by resistors R3 and R4, thereby maintaining Q1 in its on state. Once Q1 starts to conduct, current begins to flow via resistor R5, and the gate voltage V₂ of M1 drops to the point set by the voltage divider formed by resistors R2 and R5. This in turn switches M1 into its on state.

The load capacitance C_{L} becomes partially charged during the time period from t₁ to t₂ via the current limiting resistor R1, which limits the inrush current through the relay SW1 during the off state of M1. That partial charge voltage level is set by the relative values of resistor R1 and load resistance R_{L}. After M1 turns on, it shunts the current limiting resistor R1 and forms a low-resistance current path from the power source to the load. The load capacitance will then be charged to the full voltage level of the power source, as indicated in the portion of the V₁ plot following time t₂.

As is apparent from the inrush current plot in FIG. 2, the current flow through the relay in this embodiment will have two current transients: one immediately after the relay is closed at time t=t₁, and another when M1 changes from its off state to its on state at time t=t₂. The current limiting circuit of FIG. 1 may be advantageously configured such that neither of these two transients will exceed the switching current rating of the relay SW1.

The particular switching configuration of the FIG. 1 embodiment, as illustrated in the FIG. 2 plots, should not be construed as a requirement of the invention. Alternative embodiments may utilize other configurations, as previously indicated herein.

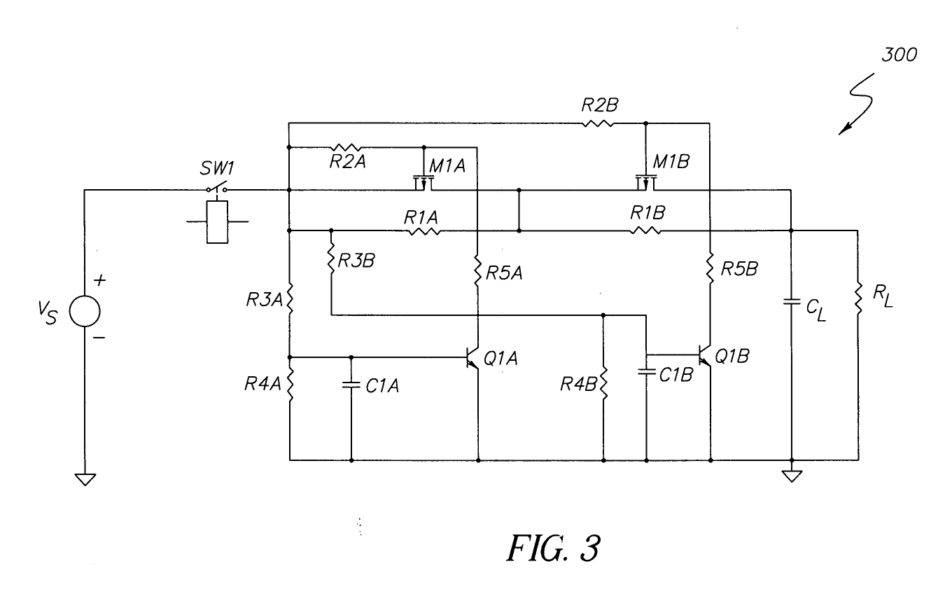

FIG. 3 shows a system 300 which includes an inrush current limiting circuit in accordance with another illustrative embodiment of the invention. The system 300, like the system 100 of FIG. 1, comprises DC power source V_{S} which is connectable via relay SW1 to a load comprising a parallel arrangement of load capacitance C_{L} and load resistance R_{L}. However, the current limiting circuit in system 300 is a two-stage current limiting circuit which comprises two of the FIG. 1 current limiting circuits connected in series. The two circuits are generally denoted as circuits A and B in FIG. 3, with each including the same set of components as the FIG. 1 current limiting circuit but with the components in FIG. 3 being denoted by a corresponding A or B suffix. Thus, in this arrangement, there are two current limiting resistors R1A and RIB connected in series between the input and output of the FIG. 3 current limiting circuit, and two corresponding power MOSFETS M1A and M1B connected in parallel with the respective current limiting resistors R1A and R1B. The other FIG. 1 components are duplicated in a similar manner in the FIG. 3 embodiment.

The operation of each stage of the two-stage current limiting circuit of FIG. 3 is substantially the same as that previously described for the single-stage current limiting circuit of FIG. 1. A particular advantage of the two-stage arrangement is that it can accommodate a higher level transient for a given set of components than the single-stage arrangement. Those skilled in the art could readily determine appropriate component values for a given implementation of the two-stage circuit of FIG. 3. Also, additional stages may be used, or different component types and values, as required, in order to accommodate the transient suppression needs of a particular application.

The invention in the illustrative embodiments described above provides inrush current limiting circuits which utilize a designated time constant to control switching of an FET or other type of controllable shunt element in the presence of a transient current spike. This advantageously avoids the problems associated with the previously-described conventional arrangements involving the use of thermistors or the sensing of actual transient current or load voltage. For example, the illustrative embodiments allow the switching state of the FET to be determined with sufficient accuracy to ensure that the inrush current limiting circuit satisfies the current rating requirements of the relay for a given set of source and load parameters.

All documents, patents, journal articles and other materials cited in the present application are hereby incorporated by reference.

It should again be emphasized that the particular embodiments described above are presented by way of illustrative example only. Alternative embodiments may utilize different circuit configurations, different component types and values, different switching characteristics, etc. These and other alternative embodiments within the scope of the appended claims will be readily apparent to those skilled in the art.

### Parts List

V_{S} power source

SW1 relay

C_{L} load capacitance

R_{L} load resistance

R1, R1A, R1B current limiting resistors

M1, M1A, M1B power MOSFETs

102 control circuit

102a, 102b control circuit portions

104 time delay circuit

R2-R5, R2A-R5A, R2B-R5B resistors

C1, C1A, C1B capacitors

Q1, Q1A, Q1B bipolar transistors

I inrush current

V₁ load voltage

V₂ gate voltage

V₃ base voltage

t time

t₁, t₂ times

1. A current limiting circuit, comprising:
a current limiting element coupled between an input and an output of the current limiting circuit;
a controllable shunt element connected in parallel with the current limiting element;
a control circuit configured to generate a control signal for application to a control input of the shunt element for controlling the shunt element between at least a first state and a second state responsive to a timing signal; and
a time delay circuit configured to generate the timing signal, the time delay circuit being coupled between the input of the current limiting circuit and an input of the control circuit, the time delay circuit generating the timing signal based on a designated time constant and in a manner substantially independent of an amount of current passing through the current limiting element.

2. The current limiting circuit of claim 1 wherein the current limiting element comprises a current limiting resistor.

3. The current limiting circuit of claim 1 wherein the controllable shunt element comprises a MOSFET device with its gate corresponding to the control input.

4. The current limiting circuit of claim 3 wherein the gate of the MOSFET device is coupled via a first resistor of a divider circuit to an output terminal of a bipolar transistor of the control circuit, and is coupled via a second resistor of the divider circuit to an input of the current limiting circuit.

5. The current limiting circuit of claim 3 wherein the MOSFET device is coupled at its source and drain terminals between the input and output of the current limiting circuit.

6. The current limiting circuit of claim 5 wherein the MOSFET device comprises a p-channel MOSFET device having its source terminal coupled to the input of the current limiting circuit and its drain terminal coupled to the output of the current limiting circuit.

7. The current limiting circuit of claim 1 wherein the control circuit comprises a bipolar transistor with its base coupled to an output of the time delay circuit.

8. The current limiting circuit of claim 7 wherein the bipolar transistor comprises an NPN bipolar transistor having its collector coupled to the control input of the controllable shunt element and its emitter coupled to a circuit potential of the current limiting circuit.

9. The current limiting circuit of claim 8 wherein the circuit potential of the current limiting circuit comprises a ground potential of the current limiting circuit.

10. The current limiting circuit of claim 7 wherein the control circuit further comprises a divider circuit having a first resistor and a second resistor, an output terminal of the bipolar transistor being coupled via the first resistor of the divider circuit to the control input of the controllable shunt element, the control input of the controllable shunt element being connected via the second resistor of the divider circuit to the input of the current limiting circuit.

11. The current limiting circuit of claim 10 wherein the output terminal of the bipolar transistor comprises a collector terminal of an NPN bipolar transistor.

12. The current limiting circuit of claim 1 wherein the time delay circuit comprises a resistor coupled between the input of the current limiting circuit and the input of the control circuit, and a capacitor coupled between the input of the control circuit and a circuit potential of the current limiting circuit, values of the resistor and capacitor establishing the designated time constant for generation of the timing signal in a manner substantially independent of an amount of current passing through the current limiting element.

13. The current limiting circuit of claim 12 wherein the circuit potential of the current limiting circuit comprises a ground potential of the current limiting circuit.

14. The current limiting circuit of claim 12 wherein the time delay circuit further comprises an additional resistor, coupled between the input of the control circuit and the circuit potential, in parallel with the capacitor.

15. The current limiting circuit of claim 1 wherein when the shunt element is in the first state, current between the input and output of the current limiting circuit passes primarily through the current limiting element, and wherein when the shunt element is in the second state, current between the input and output of the current limiting circuit passes primarily through the shunt element.

16. The current limiting circuit of claim 1 wherein the current limiting element is operative to suppress current between the input and output of the current limiting circuit in the presence of an initial transient current spike resulting when a power source is coupled to a load via the current limiting circuit.

17. The current limiting circuit of claim 1 wherein the circuit is coupled between a power source and a load.

18. The current limiting circuit of claim 1 wherein the circuit comprises a multi-stage circuit having at least two current limiting elements arranged in series with one another, and at least two controllable shunt elements each connected in parallel with a corresponding one of the current limiting elements.

19. A method for use in a current limiting circuit, the current limiting circuit comprising a current limiting element coupled between an input and an output of the current limiting circuit and a controllable shunt element connected in parallel with the current limiting element, the method comprising the steps of:
generating a control signal for application to a control input of the shunt element for controlling the shunt element between at least a first state and a second state responsive to a timing signal; and
generating the timing signal based on a designated time constant and in a manner substantially independent of an amount of current passing through the current limiting element.

20. A system, comprising:
a power source;
a load; and
a current limiting circuit coupled between the power source and the load;
the current limiting circuit comprising:
a current limiting element coupled between an input and an output of the current limiting circuit;
a controllable shunt element connected in parallel with the current limiting element;
a control circuit configured to generate a control signal for application to a control input of the shunt element for controlling the shunt element between at least a first state and a second state responsive to a timing signal; and
a time delay circuit configured to generate the timing signal, the time delay circuit being coupled between the input of the current limiting circuit and an input of the control circuit, the time delay circuit generating the timing signal based on a designated time constant and in a manner substantially independent of an amount of current passing through the current limiting element.
